(19) United States
(12) Patent Application Publication
(10) Pub. No.: US 2010/0198458 A1
(43) Pub. Date: Aug. 5, 2010

(54) NAVIGATION SYSTEM WITH HAPTIC ASSIST

(75) Inventors: Pietro Buttolo, Dearborn Heights, MI (US); James Stewart Rankin, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/363,953

(22) Filed: Feb. 2, 2009

(51) Int. Cl. G01C 21/36

(52) U.S. Cl. 701/36; 701/200

(57) ABSTRACT

An apparatus and method of indicating to a vehicle operator a desired left/right direction of a turn required to follow a desired route generated by a navigation system. Haptic stimuli are provided to the operator in advance of the turn point by activating vibration generators to create vibrations in a steering input controller, such as a steering wheel, contacted by one or both hands of the operator. The vibration generators are activated in a sequence to generate haptic stimuli that are distinguishable by the operator as progressing through the steering input controller in a pattern indicating a left turn versus a pattern that indicates a right turn. Additional information related to the turn point is haptically communicated, such as a required lane change, a traffic signal, or a relative sharpness of the turn.

### BACKGROUND

1. Technical Field

The invention relates to navigation systems used in automotive vehicles to inform the operator of a desired route, and specifically to a system for providing haptic notifications of an upcoming turns to the operator.

2. Background Art

Navigation systems for automotive vehicles are used to provide a vehicle operator with directions and other information about a desired driving route. A pre-planned route may be programmed into the system by manual inputs made by the operator and/or by other data transfer means. Recommended route information may be provided from sources off-board the vehicle, such as a re-route based on information from a real-time traffic-alert system.

An important consideration in the design of such navigation systems is the manner in which driving directions as to how to follow the desired route are communicated to the vehicle operator. Such directions are preferably communicated to the operator in a manner that does not require him/her to look at a map or other visual display while the vehicle is in motion. Voice-command systems have been proposed, but spoken directions from the navigation system may interfere with sounds from other in-car systems. Examples of such other systems are an audio entertainment system, a hands-free cell phone, and audible alerts/warnings regarding the status of other vehicle systems. Systems have been proposed that provide a vehicle operator with various types of tactile or haptic alerts. U.S. Pat. No. 7,102,496B1 teaches a steering wheel shaker to warn a vehicle operator of a possible collision risk detected by various external sensors such as radar or optical sensors. The reference also teaches haptically alerting the operator to roadway environmental attributes such as changes in grade, curves, intersections, road surface conditions, special roadways, straight roadways, surface types, and travel lanes.

US Patent Application 2007/005027A1 teaches a method of assisting a vehicle operator to negotiate a roadway. The method includes identifying a curve in the roadway ahead of the vehicle and advising the vehicle operator of the approaching curve by means of a haptic actuator.

It has also been proposed to signal an approaching turn through vibrations on a steering wheel fitted with vibrating motors on the left side and the right side of the wheel. Turn-by-turn directions generated by a navigation system are sent to the steering wheel and the direction of the turn is indicated by causing one of the two motors vibrate before coming to a junction. The vibration starts 15 seconds before the junction and the strength and duration of each vibration increases as the junction nears. A problem with this concept is that different drivers have different styles of holding the steering wheel, so it is difficult to communicate the turn direction effectively regardless of where the driver's hand or hands are contacting the steering wheel.

### SUMMARY

In a first disclosed embodiment, a haptic-assist navigation system is provided for a vehicle having a steering input controller manipulated by a vehicle operator. The system comprises a navigation unit generating a route advisory indicating an upcoming turn in a desired left/right direction at an action point, and at least two vibration generators disposed on the steering input controller that are activated in response to the route advisory to create direction-specific haptic stimuli in the steering input controller. The vibration generators are activated in a sequential manner that creates haptic stimuli in the steering input controller that are sensed by the operator as originating in a first location on the steering input controller and progressing to a second location on the steering input controller. The direction-specific stimuli provide the vehicle operator with an indication of the direction of the upcoming turn that is intuitively understood regardless of where on the steering input controller the driver's hand or hands are making contacting with the steering input controller.

In a preferred embodiment, the haptic stimuli are produced in a steering wheel by vibration generators disposed around the circumference of a steering wheel. A haptic controller receives the route advisory information from the navigation unit and creates a haptic message in the form of a sequence of signals to be delivered to the operator prior to the action point. The vibration generators are energized in accordance with the haptic messages generated by a haptic controller.

A further disclosed embodiment provides a method of operating a haptic-assist direction system to indicate to a vehicle operator a desired direction of a turn required at an action point to follow a desired route. The method comprises the step of activating a plurality of vibration generators disposed in spaced relationship to one another on a steering input controller in a sequence to create vibrations in the steering input controller that are distinguishable by the vehicle operator as progressing from a first location on the steering input controller toward a second location on the steering input controller, a direction of the progression indicating the desired direction of the turn.

### BRIEF DESCRIPTION OF THE DRAWINGS

The features of the present invention are set forth with particularity in the appended claims. The present invention, both to its organization and manner of operation, together with further objectives and advantages thereof, may be best understood with reference to the following description, taken in connection with the accompanying drawings in which:

FIG. 1 is a schematic diagram of a vehicle equipped with a navigation system capable of receiving radio frequency signal;

FIG. 2 is a schematic diagram of a navigation system with a haptic assist;

FIG. 3 is a graph showing a first example of activation of vibration generators;

FIG. 4 is a graph showing a second example of activation of vibration generators;

FIG. 5 is a graph showing a third example of activation of vibration generators;

FIG. 6 is a graph showing a fourth example of activation of vibration generators; and

FIG. 7 is a graph showing a fifth example of activation of vibration generators.

### DETAILED DESCRIPTION OF THE EMBODIMENT(S)

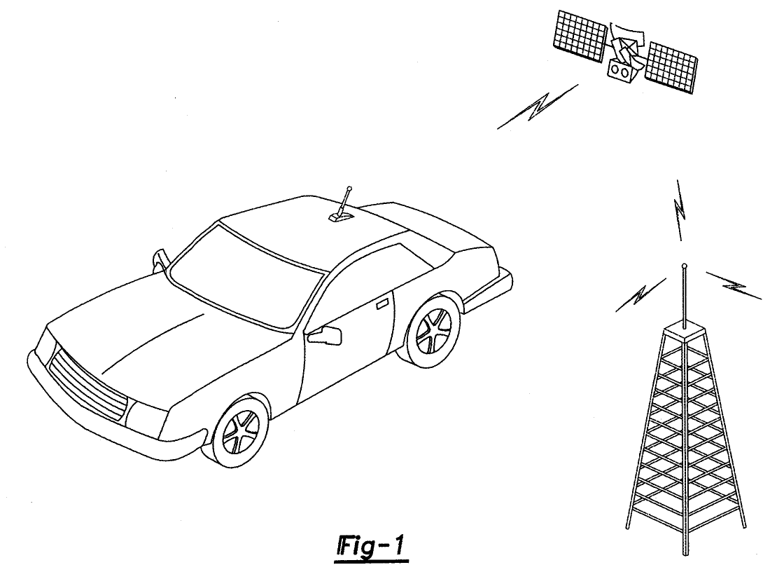

FIG. 1 generally depicts an automotive vehicle 2 equipped with a navigation system. As is well known, such navigation systems may receive radio frequency (RF) signals from off-board sources such as a satellite 4 and a ground-based transmitter 6. The RF signals may, for example, be Global Positioning System (GPS) signals.

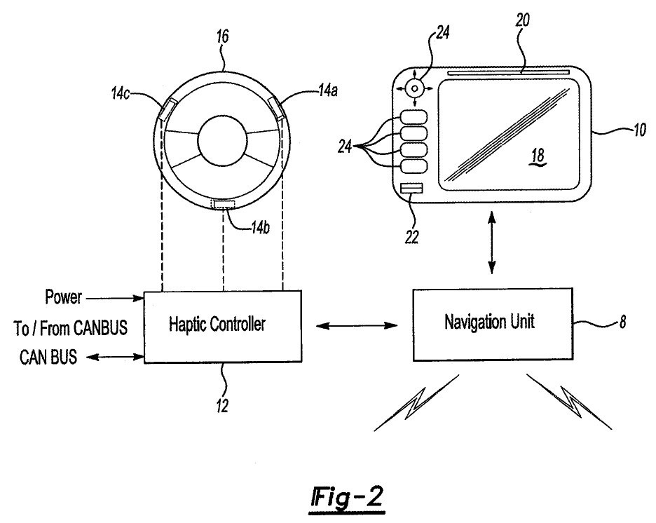

As shown schematically in FIG. 2, a haptic assist navigation system of the type that may be installed in automotive vehicle 1 includes a navigation unit 8, a display/interface (D/I) module 10, a haptic controller 12, and a plurality of vibration generators 14a, 14b, 14c. Vibration generators 14a, 14b, 14c are disposed on a steering input controller 16. Steering input controller 16 is illustrated as being a generally circular steering wheel, but any configuration of steering input controller adapted to be manipulated by one or both hands of a vehicle operator may be employed.

Navigation unit 8, as is well known in the art, may include a GPS-based receiver, a map database, and related hardware and software as required to allow the location of the vehicle to be precisely determined and plotted in relation to cultural features, such as roadways, present in the map database. Navigation unit 8 may also include (or be networked with) an RF receiver to allow reception of data from off-board sources such as satellite 4 and ground-based transmitter 6. Off-board sources may provide real-time or near-real-time data such as traffic or weather information. Navigation unit 8 may include (or be networked with) other types of receivers (infrared, Wi-Fi, etc.) to allow transfer of information into and/or out of the navigation unit 8.

D/I module 10 may include a video display screen 18 (LED, plasma, LCD, or any appropriate type), manual input controls 24 (such as pushbuttons, rocker switches, touchpads, etc.), a CD-ROM receptacle 20, a USB connector port 22, and a voice module (not shown). Video display screen 18 may include a touch-screen feature to allow manual inputs. CD-ROM receptacle 20 and USB port 22 may be used to load information into the map database of navigation unit 8.

The schematic system architecture depicted in FIG. 2 is for clarity of description and is not intended to limit the scope of the present invention, as many other system architectures are possible. For example, navigation unit 8 and D/I module 10 may be integrated into a single unit as installed in a vehicle. Also, haptic controller 12 need not be a physically separate unit, but may be a function or process integrated with or residing on navigation unit 8 or another electronic control module (not shown) of the vehicle. As indicated schematically in FIG. 2, haptic controller 12 may be connected with a CAN (Car Area Network) bus to exchange information with a multitude of other vehicle systems.

A vehicle operator (or other occupant) uses D/I module 10 to enter or select a desired route and/or destination into navigation unit 8. This may be accomplished by using the manual input controls 24 in combination with menus and other information displayed on video display screen 18. A desired route and/or destination may also be loaded into navigation unit 8 using CD-ROM receptacle 20, USB port 22, or an appropriate wireless link. If only a desired destination is entered into navigation unit 8, navigation unit 8 may calculate a desired route to the desired destination using the database information regarding roadways and other cultural features to achieve a shortest trip distance and/or a shortest trip time.

As is well known in the art, navigation unit 8 generates route advisories such as turn-by-turn directions required to move the vehicle 2 along the desired route from its present position. Turn-by-turn directions typically take the form of an instruction or notification that a turn to the left or right should be executed at an approaching action point (such as a road intersection, ramp, junction, split, driveway, parking lot entrance, etc.) in order to follow the desired route. A distance from the vehicle's present position to the required action point may also be given.

The route advisories may be communicated to the vehicle operator by visual and/or audible commands generated by D/I module 10. The directions may also be communicated to the vehicle operator on a separate visual display (not shown) located in a position to be conveniently viewed by the operator, such as a heads-up display.

Vibration generators 14a, 14b, 14c are preferably located on or closely adjacent to the portions of steering input controller 16 that are likely to be contacted by the hand or hands of the driver when operating the vehicle. For example, a conventional, generally circular steering wheel may have vibration generators 14a, 14b, 14c located on the periphery of the wheel. In the embodiment depicted in FIG. 2, three vibration generators 14a, 14b, 14c are employed and are disposed around the circumference of steering input controller 16 at or near the 10 o'clock, 2 o'clock, and 6 o'clock positions.

Vibration generators 14a, 14b, 14c are preferably small, electrically powered devices capable of producing mechanical vibrations of sufficient strength to be easily detected by the hands of the vehicle operator. The so-called “vibromotors” commonly used in cell-phones and pagers are one example of the type of device that may serve as vibration generators 14a, 14b, 14c, as they are inexpensive, power efficient, and durable. Motor drivers (not shown) may be required to amplify and/or condition the electric power supplied by the vehicle electrical system to match the power requirements of vibration generators 14a, 14b, 14c.

As illustrated in FIG. 2, haptic controller 12 receives a high-level instruction from navigation unit 8 such as “signal operator that a right turn is approaching in 2 miles”. Haptic controller 12 then converts the high-level instruction into one or more haptic messages that activate vibration generators 14a, 14b, 14c. A haptic message is one or more sequences of vibrations delivered by vibration generators 14a, 14b, 14c to steering input controller 16 that, when sensed by the vehicle operator, communicate the substance of the high-level instruction.

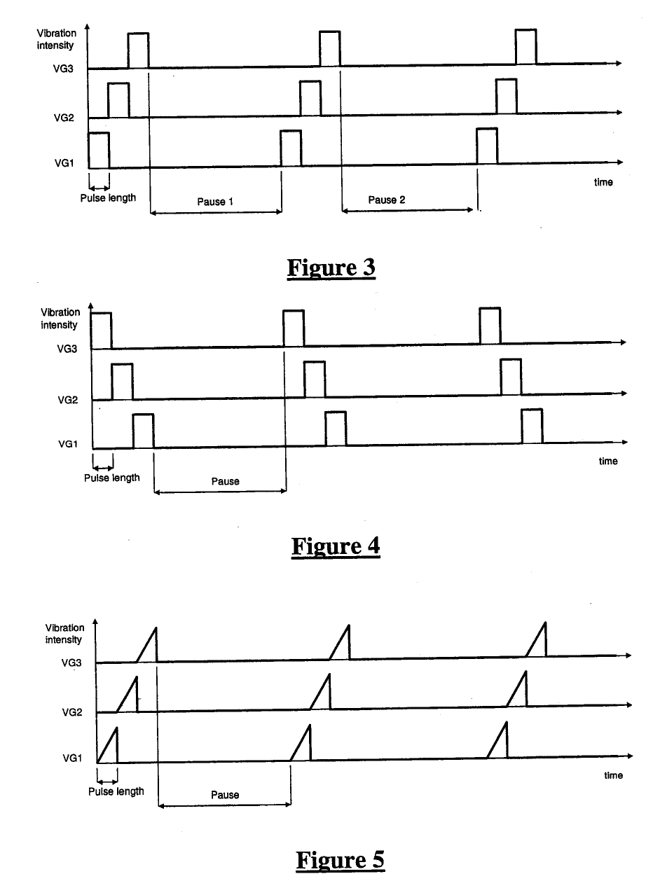

Haptic messages may direct activation of vibration generators 14a, 14b, 14c in a sequence to create vibrations in steering input controller 16 that may be sensed by the driver as direction-specific haptic stimuli. FIGS. 3-7 illustrate various examples of such sequences using graphs that show the activation time and intensity of each of the three vibration generators. In FIGS. 3-7, the traces representing vibration generators 14a, 14b, 14c are labeled on the Y-axis as VG1, VG2, and VG3, respectively.

In the sequence shown in FIG. 3, vibration generator 14a is first activated for a period of time to create a pulse length (50 milliseconds, for example), followed by vibration generator 14b for an equal or nearly equal pulse length, followed by vibration generator 14c for an equal or nearly equal pulse length. This sequence of pulses creates haptic stimulus in steering input controller 16 that are sensed by the vehicle operator as progressing in a clockwise direction around the perimeter of the steering input controller, thereby indicating to the driver an upcoming right turn.

The haptic message of FIG. 3 shows the sequence repeated three times with a pause (of approximately 600 msec, for example) between each repetition, but there may be any number of repetitions of the sequence leading up to the action point. To give the vehicle operator an indication of the time or distance remaining to the desired turn, the length of the pause between sequences may decrease as the time/distance to the turn decreases. This would be graphically depicted by Pause 1 being greater than Pause 2. In one possible implementation, the pause between pulse sequences may decrease to near zero at the action point to give a continuous vibration.

FIG. 4 illustrates a haptic message comprising a sequential activation of vibration generators 14a, 14b, 14c in reverse order from that shown in FIG. 3, beginning with 14c (VG3), then 14b (VG2), and then 14a (VG1). This sequence creates haptic stimuli sensed by the vehicle operator as progressing in a counterclockwise direction around the perimeter of the steering input controller, thereby indicating to the driver an upcoming left turn.

FIG. 5 illustrates a haptic message in which vibration generators 14a, 14b, 14c are activated in the same order as the example of FIG. 3, but in this example the intensity of the vibration produced by each VG ramps upward to a peak then terminates, in a “sawtooth” pulse pattern.

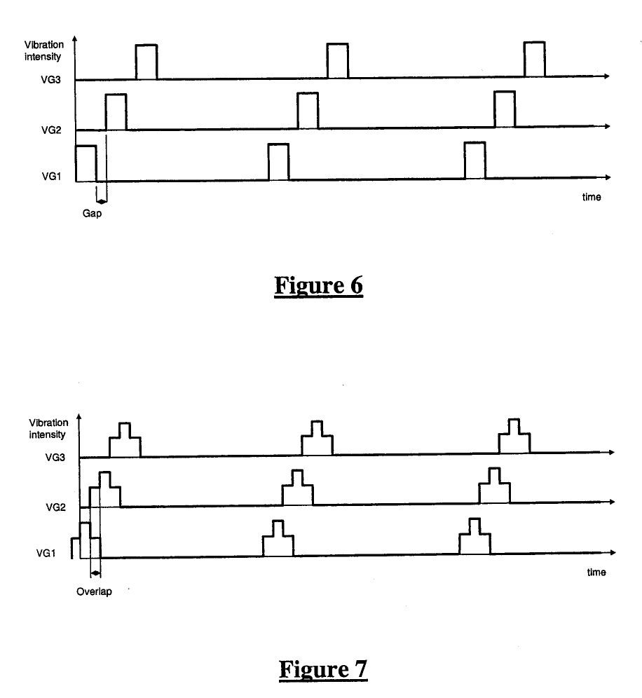

FIG. 6 illustrates a haptic message in which vibration generators 14a, 14b, 14c are activated in the same order as the example of FIG. 3, but in this example there is a short delay or gap between the activation of each VG in the sequence.

FIG. 7 illustrates a haptic message in which each VG is activated in a “stair-step” pulse having varying intensity and the pulses making up each sequence overlap one another in time.

FIGS. 3-7 show only a sampling of possible pulse sequences and haptic messages according to the invention. A haptic message may comprise any number of repetitions of sequences, with any combination of gradual and/or distinct changes in duration or intensity.

Experiments have shown that haptic messages comprising the sequential activation of vibration generators 14a, 14b, 14c such as shown in FIGS. 3-7 produce a vibration pattern in steering input controller that may be intuitively recognized by a vehicle operator regardless of whether one or both of the operator's hands are contacting the steering input controller, and also regardless of where on the steering input controller this contact occurs.

The intensity and/or modulation of the vibrations making up the haptic message can be used to indicate information other than solely the direction of the turn required at the upcoming action point. For example, greater intensity could be used to signal that the approaching action point requires a turn that is sharper than may be comfortably made at the vehicle's current speed, thereby giving the operator an advisory that vehicle speed should be decreased.

Other possible action point characteristics that may be indicated using haptic messages are the presence of traffic control signals and the requirement that the vehicle change into a different traffic lane (such as a “right turn only” lane) prior to the action point.

The duty cycle of vibration generators 14a, 14b, 14c (the relative time the vibration is off or at a reduced level) can be varied to create different haptic stimuli sensed by the vehicle operator. A low duty cycle may be used to generate relatively gentle stimulus while high duty cycle gives a somewhat harsher stimulus. Harsher stimulus may be used to signal event that could affect vehicle safety, while gentler stimulus is used to convey directional information.

While the disclosed embodiment is applied to a conventional, generally circular steering input controller 16, the invention may be practiced in relation to any type of steering input controller that is held, grasped, gripped, touched, or otherwise contacted by either or both the left and right hands of the vehicle operator.

While the best mode for carrying out the invention has been described in detail, those familiar with the art to which this invention relates will recognize various alternative designs and embodiments for practicing the invention as defined by the following claims.

What is claimed:

1. A haptic-assist navigation system for a vehicle comprising:
a steering input controller for actuation by a vehicle operator;
a navigation unit generating a route advisory indicating an upcoming turn in a desired left/right direction at an action point;
at least two vibration generators disposed on the steering input controller at locations spaced from one another, the vibration generators being activated to vibrate in response to the route advisory and in advance of the action point to create direction-specific haptic stimuli in the steering input controller, the vibration generators being activated in a first sequence to indicate the desired right direction and in a second sequence to indicate the desired left direction.

2. The apparatus according to claim 1 further comprising a haptic controller receiving the route advisory and generating a haptic message corresponding to the desired left/right direction, activation of the vibration generators being in accordance with the haptic message.

3. The apparatus according to claim 1 wherein the steering input controller is a generally circular steering wheel and the vibration generators are disposed around a circumference of the steering wheel.

4. The apparatus according to claim 3 wherein the first sequence is a clockwise progressing sequence and the second sequence is a counter-clockwise progressing sequence.

5. The apparatus according to claim 3 wherein the vibration generators are disposed at equally spaced locations around the circumference of the steering wheel.

6. The apparatus according to claim 1 wherein the vibration generators are activated to create a series of haptic stimuli, progressive stimuli of the series indicating a decreasing distance to the action point.

7. The apparatus according to claim 1 wherein the haptic stimuli further indicate an expected characteristic of the action point.

8. The apparatus according to claim 7 wherein the characteristic of the action point comprises a relative sharpness of the turn.

9. The apparatus according to claim 7 wherein the characteristic of the action point comprises a required lane change prior to the action point.

10. The apparatus according to claim 7 wherein the characteristic of the action point comprises a traffic control signal associated with the action point.

11. The apparatus according to claim 1 further comprising a operator interface for communicating route information to the operator and allowing the operator to input commands to the navigation unit.

12. A method of operating a haptic-assist direction system to indicate to a vehicle operator a desired direction of a turn required at an action point to follow a desired route, the method comprising the following step:
activating a plurality of vibration generators disposed in spaced relationship to one another on a steering input controller in a sequence to create vibrations in the steering input controller that are distinguishable by the vehicle operator as progressing from a first location on the steering input controller toward a second location on the steering input controller, a direction of the progression indicating the desired direction of the turn.

13. The method according to claim 12 wherein the haptic stimuli comprise a series of signals delivered prior to the action point, progressive signals of the series indicating a decreasing distance to the action point.

14. The method according to claim 12 wherein the haptic stimuli indicate a characteristic of the action point.

15. The method according to claim 14 wherein the characteristic of the action point comprises a relative sharpness of the turn.

16. The method according to claim 14 wherein the characteristic of the action point comprises a required lane change prior to the action point.

17. The method according to claim 14 wherein the characteristic of the action point comprises a traffic control signal associated with the action point.

18. The method according to claim 12 wherein the vibration generators are activated in accordance with a haptic message generated by a haptic controller receiving the route advisory, the haptic message corresponding to the desired left/right direction.

19. The method according to claim 12 wherein the direction of the progression is in a clockwise direction to indicate a right turn.

20 A haptic-assist navigation system for a vehicle comprising:
a steering wheel for actuation by a vehicle operator;
a navigation unit generating a route advisory indicating an upcoming turn in a desired left or right direction at an action point;
at least two vibration generators disposed on the steering wheel at locations spaced from one another around a periphery of the steering wheel, the vibration generators being activated to vibrate in response to the route advisory and in advance of the action point, the vibration generators being activated in a clockwise progressing sequence to create vibrations that may be sensed by the vehicle operator to indicate a right turn and in a counterclockwise sequence to indicate a left turn.
